(19) United States
(12) Patent Application Publication
(10) Pub. No.: US 2026/0063411 A1
(43) Pub. Date: Mar. 5, 2026

(54) DEVICE FOR IDENTIFYING BOLTS AND NUTS

(71) Applicant: Juan Ehringer, Gainesville, FL (US)

(72) Inventor: Juan Ehringer, Gainesville, FL (US)

(21) Appl. No.: 19/305,636

(22) Filed: Aug. 20, 2025

Related U.S. Application Data
(60) Provisional application No. 63/662,304, filed on Jun. 20, 2024.

(51) Int. Cl. G01B 5/20; G01B 5/16

(52) U.S. Cl. CPC G01B 5/204; G01B 5/163

(57) ABSTRACT

A device for identifying bolts and nuts can include a plurality of threaded bodies, wherein each threaded body of the plurality of threaded bodies includes: a female threaded portion; and a male threaded portion, the male threaded portion being connected to the female threaded portion; wherein the female threaded portion and the male threaded portion extend in opposite directions; a flexible connector including a plurality of flexible portions that connect the plurality of threaded bodies; wherein each flexible portion of the plurality of flexible portions has a height, a width and a length, the length being larger than the width, and the height being larger than the width so that the flexible connector is more flexible along a first plane than a second plane perpendicular to the first plane.

### TECHNICAL FIELD

The embodiments generally relate to the field of devices for identifying bolts and nuts.

### BACKGROUND

Typical devices for identifying bolts and nuts can be rigid and difficult to store in small tool bags and tool boxes.

There is a need for a device that identifies bolts and nuts which can be made more compact for easier storing.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

In general, the disclosed device for identifying bolts and nut scan include a plurality of threaded bodies, wherein each threaded body of the plurality of threaded bodies includes: a female threaded portion; and a male threaded portion. The male threaded portion can be connected to the female threaded portion; wherein the female threaded portion and the male threaded portion extend in opposite directions. A flexible connector can include a plurality of flexible portions that connect the plurality of threaded bodies; wherein each flexible portion of the plurality of flexible portions has a height, a width and a length, the length being larger than the width, and the height being larger than the width so that the flexible connector is more flexible along a first plane than a second plane perpendicular to the first plane.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIGS. 1-6 illustrate devices for identifying bolts and nuts, according to some embodiments disclosed herein.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described product or methods of use. Any specific details of the embodiments are used for demonstration purposes only and no unnecessary limitations or inferences are to be understood from there.

It is noted that the embodiments reside primarily in combinations of components and procedures related to the products. Accordingly, the product and components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

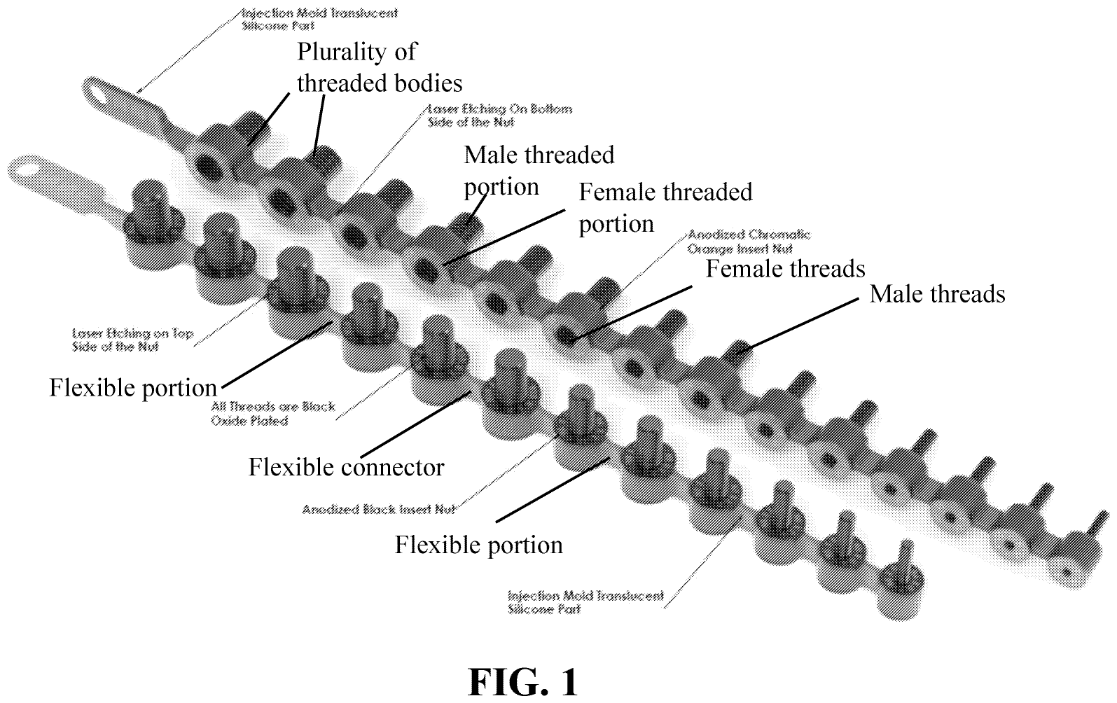

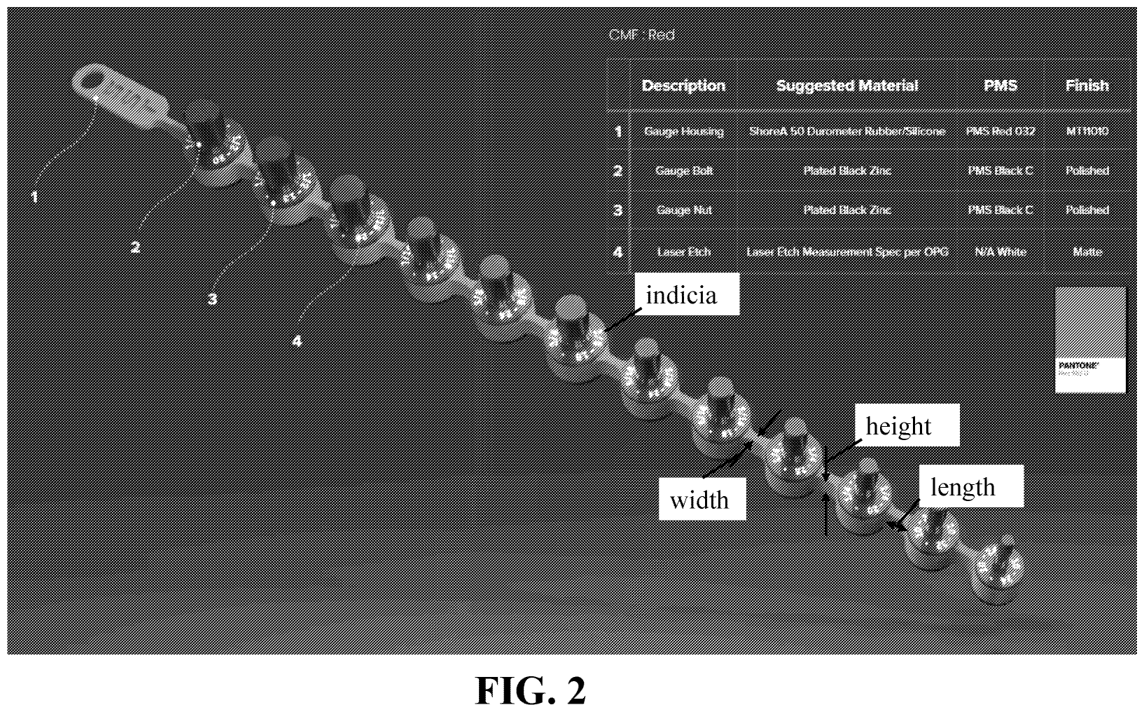

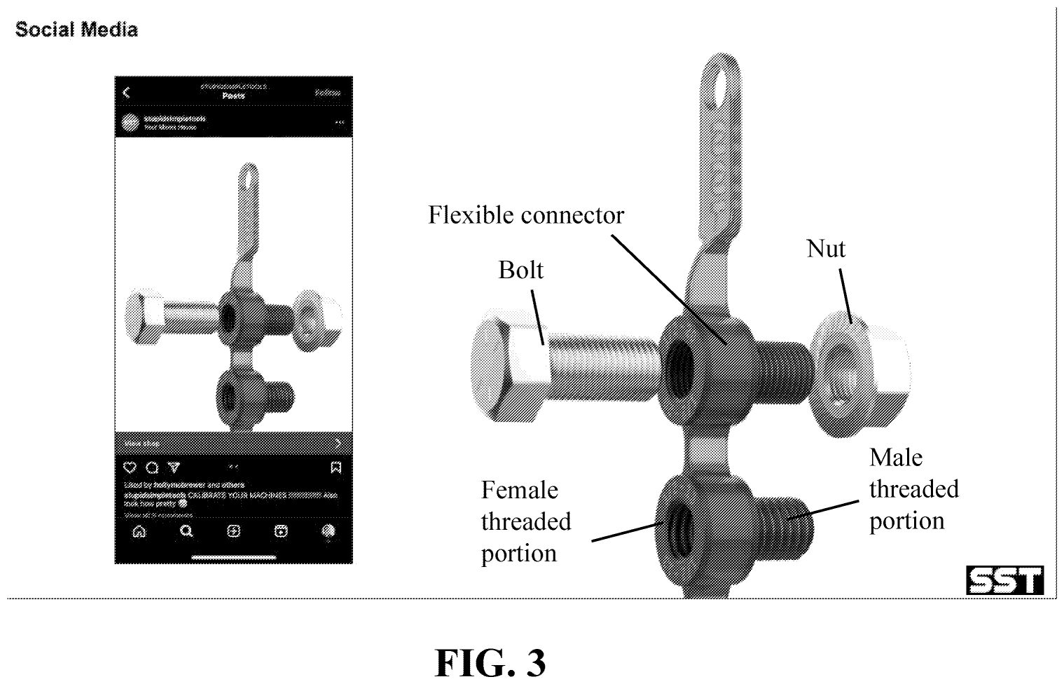

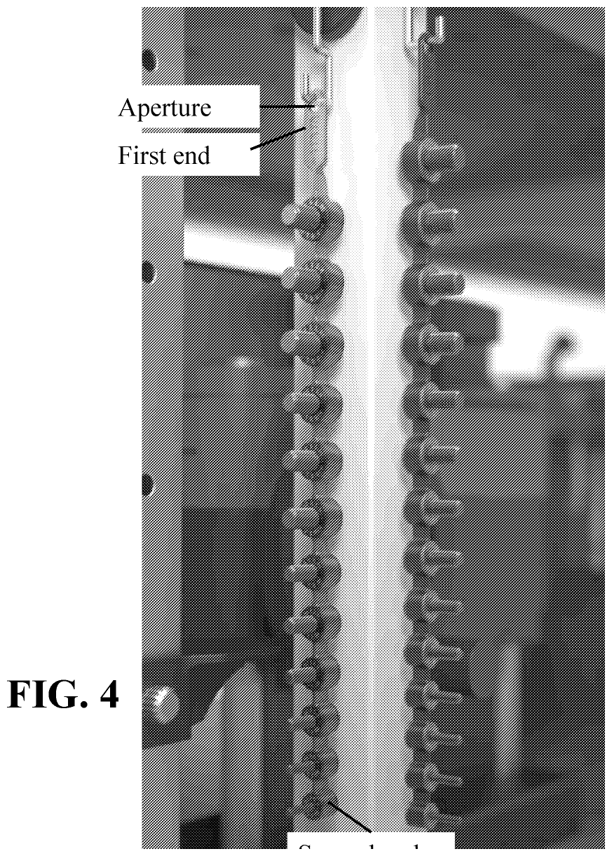

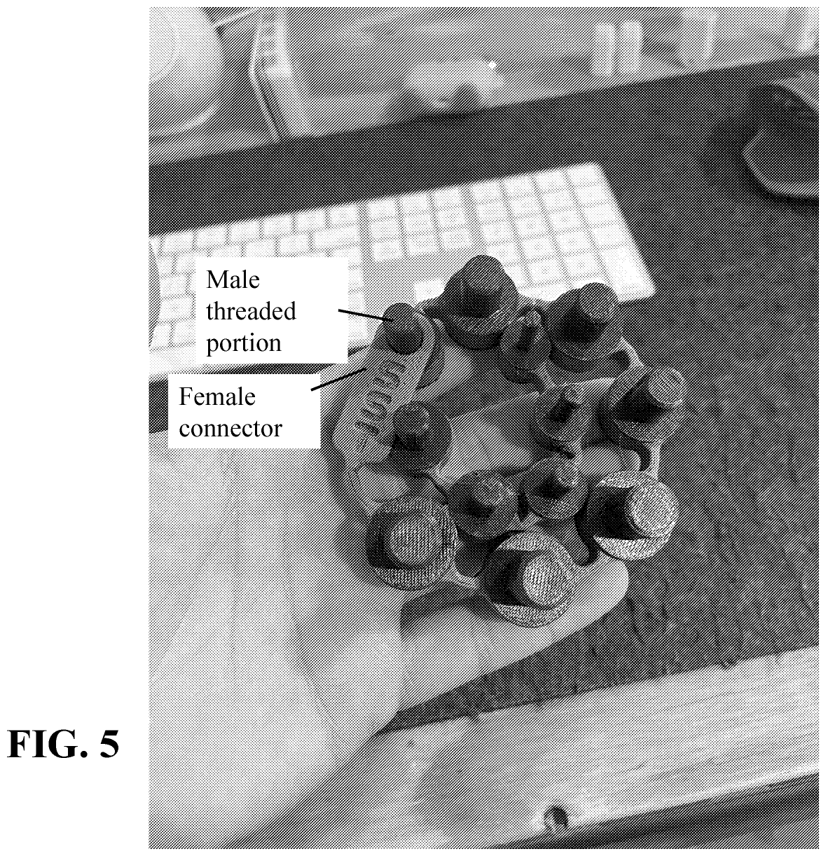

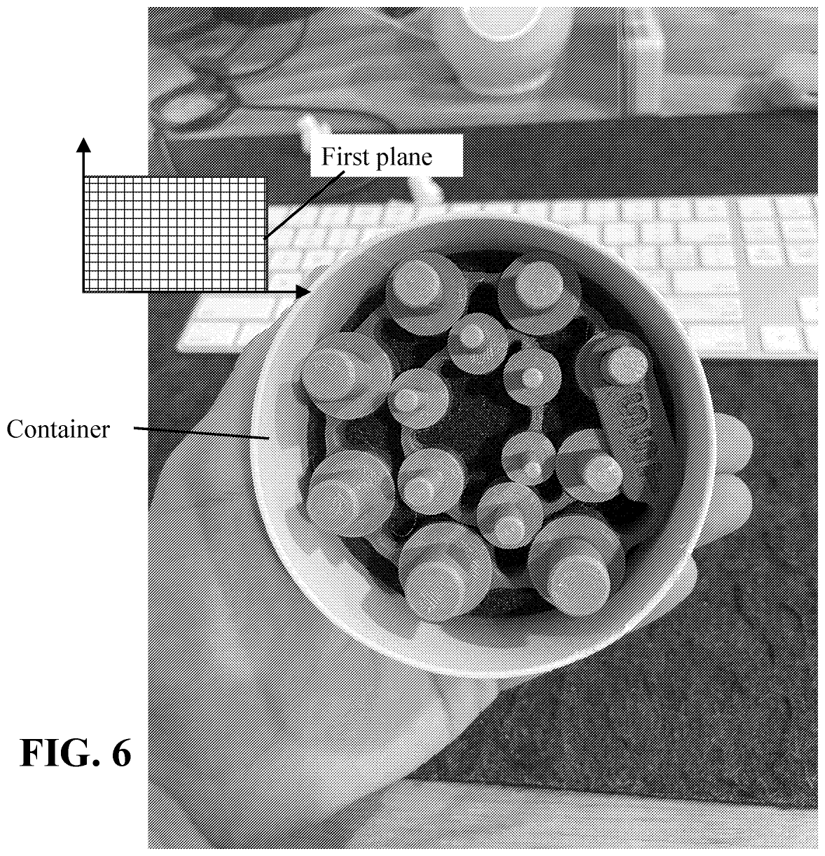

In general, the embodiments described herein relate to a device for identifying bolts and nuts. Referring to FIGS. 1-6, the device can include a plurality of threaded bodies, wherein each threaded body of the plurality of threaded bodies includes: a female threaded portion; and a male threaded portion, the male threaded portion being connected to the female threaded portion; wherein the female threaded portion and the male threaded portion extend in opposite directions.

Each female threaded portion can be con structed to receive a corresponding bolt having a same size as the female threaded portion. Each male threaded portion can be constructed to be inserted into a corresponding female threaded bore (e.g., in a nut) having a same size as the male threaded portion.

A flexible connector can include a plurality of flexible portions that connect the plurality of threaded bodies; wherein each flexible portion of the plurality of flexible portions has a height, a width and a length, the length being larger than the width, and the height being larger than the width so that the flexible connector is more flexible along a first plane than a second plane perpendicular to the first plane.

The flexible connector can be made primarily of silicone. The flexible connector can be made primarily of one or more thermoplastic elastomers. The flexible connector can be made primarily of thermoplastic polyurethane. The flexible connector can be molded at least partially over the plurality of threaded bodies.

The plurality of threaded bodies can include indicia indicating respective sizes of the plurality of female threaded portions and respective sizes of the plurality of male threaded portions.

For each threaded body of the plurality of threaded bodies: the female threaded portion can be attached to the male threaded portion, and the female threaded portion and the male threaded portion have a same size.

For each threaded body of the plurality of threaded bodies: the female threaded portion can be integral with the male threaded portion, and the female threaded portion and the male threaded portion have a same size.

The flexible connector can have a first end and a second end, wherein the first end of the flexible connector is constructed to be fastened to the second end of the flexible connector.

The flexible connector can have a first end; the first end of the flexible connector has an aperture that is sized to receive at least one male threaded portion of the plurality of threaded bodies.

The flexible connector can have a first end and a second end, wherein: the first end has a female connector; the second end has a male connector; the female connector of the first end is constructed to receive the male connector of the second end.

The male connector can include includes a protrusion; the female connector can include an aperture.

The flexible connector can have a first end and a second end, wherein: the first end is attached to a first magnet; the second end is attached to a second magnet; the first magnet and the second magnet are constructed to magnetically attach the first end to the second end.

Each of the plurality of female threaded portions can be cylindrical; and each of the plurality of male threaded portions can be cylindrical.

For each threaded body of the plurality of threaded bodies: the male threaded portion is removably connected to the female threaded portion.

For each threaded body of the plurality of threaded bodies: the male threaded portion can include a first stop protrusion; the female threaded portion can include a second stop protrusion; wherein the first stop protrusion and the second stop protrusion are constructed and arranged to engage with each other while the male threaded portion is inserted into the female threaded portion so as to limit movement of the male threaded portion in the female threaded portion in a first direction.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

What is claimed is:

1. A device for identifying bolts and nuts, comprising:
a plurality of threaded bodies, wherein each threaded body of the plurality of threaded bodies includes:
a female threaded portion; and
a male threaded portion, the male threaded portion being connected to the female threaded portion;
wherein the female threaded portion and the male threaded portion extend in opposite directions;
a flexible connector including a plurality of flexible portions that connect the plurality of threaded bodies; wherein each flexible portion of the plurality of flexible portions has a height, a width and a length, the length being larger than the width, and the height being larger than the width so that the flexible connector is more flexible along a first plane than a second plane perpendicular to the first plane.

2. The device for identifying bolts and nuts of claim 1, wherein the flexible connector is made primarily of silicone.

3. The device for identifying bolts and nuts of claim 1, wherein the flexible connector is made primarily of one or more thermoplastic elastomers.

4. The device for identifying bolts and nuts of claim 1, wherein the flexible connector is made primarily of thermoplastic polyurethane.

5. The device for identifying bolts and nuts of claim 1, wherein the flexible connector is molded at least partially over the plurality of threaded bodies.

6. The device for identifying bolts and nuts of claim 1, wherein the plurality of threaded bodies include indicia indicating respective sizes of the plurality of female threaded portions and respective sizes of the plurality of male threaded portions.

7. The device for identifying bolts and nuts of claim 1, wherein for each threaded body of the plurality of threaded bodies:
the female threaded portion is attached to the male threaded portion,
and the female threaded portion and the male threaded portion have a same size.

8. The device for identifying bolts and nuts of claim 1, wherein for each threaded body of the plurality of threaded bodies:
the female threaded portion is integral with the male threaded portion, and
the female threaded portion and the male threaded portion have a same size.

9. The device for identifying bolts and nuts of claim 1, wherein:
the flexible connector has a first end and a second end, wherein the first end of the flexible connector is constructed to be fastened to the second end of the flexible connector.

10. The device for identifying bolts and nuts of claim 1, wherein: the flexible connector has a first end;
the first end of the flexible connector has an aperture that is sized to receive at least one male threaded portion of the plurality of threaded bodies.

11. The device for identifying bolts and nuts of claim 1, wherein: the flexible connector has a first end and a second end, wherein:
the first end has a male connector;
the second end has a female connector;
the female connector of the second end is constructed to receive the male connector of the first end.

12. The device for identifying bolts and nuts of claim 11, wherein: the male connector includes a protrusion; the female connector includes an aperture.

13. The device for identifying bolts and nuts of claim 1, wherein: the flexible connector has a first end and a second end, wherein:
the first end is attached to a first magnet;
the second end is attached to a second magnet;
the first magnet and the second magnet are constructed to magnetically attach the first end to the second end.

14. The device for identifying bolts and nuts of claim 1, wherein: each of the plurality of female threaded portions is cylindrical; and each of the plurality of male threaded portions is cylindrical.

15. The device for identifying bolts and nuts of claim 1, wherein for each threaded body of the plurality of threaded bodies:
the male threaded portion is removably connected to the female threaded portion.

16. The device for identifying bolts and nuts of claim 15, wherein for each
threaded body of the plurality of threaded bodies:
the male threaded portion includes a first stop protrusion;
the female threaded portion includes a second stop protrusion;
wherein the first stop protrusion and the second stop protrusion are constructed and arranged to engage with each other while the male threaded portion is inserted into the female threaded portion so as to limit movement of the male threaded portion in the female threaded portion in a first direction.
